(19) United States
(12) Patent Application Publication
(10) Pub. No.: US 2026/0317153 A1
(43) Pub. Date: Oct. 15, 2026

(54) Automatic Changeover System

(71) Applicant: AC Distributing, Inc., Annapolis, MD (US)

(72) Inventors: Charles Blane Kleinrichert, Annapolis, MD (US); Spencer Kleinrichert, Annapolis, MD (US)

(21) Appl. No.: 19/647,820

(22) Filed: Apr. 14, 2026

Related U.S. Application Data
(60) Provisional application No. 63/788,307, filed on Apr. 14, 2025.

(51) Int. Cl. B67D 1/12; B67D 1/08

(52) U.S. Cl. CPC B67D 1/1245; B67D 1/0888

(57) ABSTRACT

An automatic changeover system is described. The system has a first inlet, a second inlet, and an outlet that are fluidly coupled at a junction. An actuated valve and a pressure regulator are fluidly coupled in series between the second inlet and the junction. A pressure sensor is positioned to sense outlet pressure. A controller is programmed to selectively actuate the actuated valve based on the outlet pressure. The actuated valve is initially closed so that only fluid from the first inlet flows to the outlet. When the outlet pressure falls below a first threshold pressure, the actuated valve is opened so that fluid from the second inlet can flow to the outlet. When the outlet pressure increases above a second threshold pressure that is higher than the first threshold pressure, the actuated valve is closed. The changeover system only requires one pressure sensor to operate.

This application claims the benefit of priority of U.S. provisional application Ser. No. 63/788307 filed on Apr. 14, 2025.

### FIELD OF THE INVENTION

The field of the invention is fluid delivery systems, more specifically, automatic changeover devices for fluid delivery systems.

### BACKGROUND

The following description includes information that may be useful in understanding the present invention. It is not an admission that any of the information provided herein is prior art or relevant to the presently claimed invention, or that any publication specifically or implicitly referenced is prior art.

Automatic changeover systems are widely used in fluid delivery systems to switch between a primary fluid source and a secondary fluid source to maintain a continuous supply of fluid to a downstream application. In typical systems, changeover occurs when the pressure associated with the primary source falls below a threshold, causing the system to switch to the secondary source.

Conventional automatic changeover systems commonly rely on pressure detection at or near respective inlet lines associated with different fluid sources. Such systems often utilize multiple pressure sensing devices, including mechanical pressure gauges, manometers, or pressure switches, to monitor conditions at each source. Control logic is then implemented based on comparisons between pressures at the respective inlets or based on threshold conditions associated with each inlet.

While these systems can provide reliable changeover functionality, the use of multiple sensing points increases system complexity, cost, and maintenance requirements. In addition, many such systems rely on threshold-based pressure switches or mechanically actuated sensing devices that provide limited resolution and may not detect subtle pressure variations or transient conditions. Some systems are designed for high pressure applications, which can further increase cost.

Some systems incorporate electronic control features, including displays, alarms, and remote monitoring capabilities. However, these systems typically retain multiple inlet-based sensing configurations and add additional components and control layers, further increasing system complexity without fundamentally simplifying the sensing architecture.

Various examples of commercially available automatic changeover systems are found here: https://www.harrisproductsgroup.com/en/Products/Gas-Manifold-Systems/Specialty-Gas/ Automatic-Changeover; https://www.assurancevalve.com/automatic-gas-cylinder-changeover-system; https://www.genstartech.com/digital-automatic-manifold-systems. Unfortunately, these solutions appear to suffer from one or more of the problems discussed above.

EP3001082B1 describes an automatic changeover device that addresses instability in switching behavior, commonly referred to as dithering. In that approach, a manually set indicator is used in combination with system state detection to distinguish between actual changeover events and transient fluctuations. While this approach can improve detection of certain conditions, it introduces additional components and relies on correlation between manually set states and system behavior rather than relying solely on pressure-based detection of system conditions.

Other examples, including CA3149565A1 and U.S. Pat. No. 5,062,443A, describe changeover systems that utilize multiple pressure sensing devices positioned along respective fluid supply lines. These systems typically operate based on pressure conditions detected at each inlet and require coordination between multiple sensing elements to determine when switching should occur. Such architectures increase the number of components required and may rely on pressure switches or other threshold-based devices that provide limited measurement resolution and/or limited adjustability.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Accordingly, there remains a need for improved automatic changeover systems that reduce system complexity, minimize the number of sensing components, and provide reliable and responsive control based on pressure conditions within the system while reducing reliance on multiple sensing locations.

### SUMMARY OF THE INVENTION

The inventive subject matter provides apparatus, systems, and methods in which an automatic changeover system selectively opens and closes a secondary fluid source. The changeover system has a first inlet, a second inlet, and an outlet that are fluidly coupled at a junction. The junction has a first port fluidly coupled with the first inlet, a second port fluidly coupled with the second inlet, and a third port fluidly coupled with the outlet.

An actuated valve and a pressure regulator are fluidly coupled in series between the second inlet and the second port of the junction. In some embodiments, the pressure regulator is positioned downstream of the actuated valve. However, it is also contemplated that the pressure regulator is positioned upstream of the actuated valve.

A pressure sensor is configured to sense outlet pressure. The pressure sensor can be positioned at or between the outlet and the junction. The pressure sensor preferably comprises a transducer that generates a continuous electrical signal in response to pressure change and has adjustable thresholds.

A controller is electrically coupled with the pressure sensor and the actuated valve. The controller comprises a processor, a non-transitory computer-readable medium, and executable software instructions. The controller is programmed to selectively actuate the actuated valve based on the outlet pressure.

The controller is programmed by a user via an interface. A user can select and adjust a first threshold pressure, referred to as a changeover pressure. The changeover pressure is selected to be less than a preferred operating pressure at the first inlet and second inlet. The preferred operating pressures at the first inlet and the second inlet are determined by the specifications and requirements of the fluid delivery system located downstream of the changeover system. A user can also select a differential pressure, which is a specified increase of pressure above the first threshold to establish a second threshold pressure. The second threshold pressure should also be less than the preferred pressures of the first and second inlets.

As an example, if the preferred pressure of the first inlet is 120 pounds per square inch (PSI), and the preferred pressure of the second inlet is 115 PSI, then the changeover pressure (i.e., first threshold pressure) can be selected as 100 PSI and the differential pressure can be selected as 10 PSI, which makes the second threshold pressure 110 PSI (e.g., 100 PSI+10 PSI).

In this example, when the first inlet pressure is initially at the preferred pressure of 120 PSI, the actuated valve is closed so that only fluid from the first inlet (e.g., primary fluid source) flows to the outlet. The outlet pressure is sensed by the pressure sensor as 120 PSI. However, when the primary fluid source is depleted, or there is a leak in the primary fluid source, or there is a high demand in the downstream system, the inlet pressure may drop below 100 PSI-the changeover pressure. Once the controller senses an outlet pressure that is less than the changeover pressure, the controller opens the actuated valve, allowing fluid from the second inlet to flow to the outlet. The actuated valve will remain open until the controller senses an outlet pressure that is greater than 110 PSI-the changeover pressure plus the differential pressure (i.e., the second threshold pressure). In this manner, the automatic changeover system keeps the outlet pressure above 100 PSI so that any fluid delivery system downstream of the outlet can continue to function properly.

The pressure regulator is set to a pressure that is between the first and second threshold pressures. This ensures that the actuated valve only closes when the first inlet pressure rises above the second threshold pressure.

The automatic changeover system simplifies existing changeover systems and reduces the number of components because it does not require any pressure sensors between the first inlet and the first port of the junction or between the second inlet and the second port of the junction. The automatic changeover system only requires one pressure sensor configured to sense the outlet pressure to operate.

In some embodiments, the automatic changeover system can also include a one-way valve (e.g., check valve) fluidly positioned between the first inlet and the first port of the junction. This prevents fluid from the second inlet from flowing into the primary fluid source. Likewise, a one-way valve can be fluidly positioned between the second inlet and the second port of the junction to prevent fluid from the primary fluid source from flowing into the secondary fluid source. This one-way valve can be positioned in series with the pressure regulator and the actuated valve and can be either upstream or downstream from the pressure regulator and the actuated valve. In some embodiments, the pressure regulator is downstream of the actuated valve and the one-way valve is downstream of the pressure regulator.

In other aspects, the automatic changeover system can also include an alarm electrically coupled with the controller programmed to notify the user when the actuated valve is open and the secondary fluid source is being consumed. The alarm can be audible, visual, tactile, or any other means for communicating a status of the actuated valve to the user.

In yet other aspects, the automatic changeover system can further comprise a housing that encloses and protects the junction, controller, pressure regulator, actuated valve, and pressure sensor.

The controller is electrically coupled with a display or interface that can receive inputs from the user for programming. The controller is also preferably programmed to show a status of the actuated valve, an outlet pressure, a software version, a setting for the first threshold pressure, a setting for the second threshold pressure, and a recommended action on the display or interface.

The automatic changeover system can be used upstream of any system that requires uninterrupted delivery of a fluid. As used herein, “fluids” refers to both gases and liquids. Contemplated applications include beverage dispensing units that require carbon dioxide (CO₂), nitrogen (N₂), or argon (Ar). Other contemplated applications include medical gas pipeline systems for oxygen (O₂) delivery and industrial gas delivery systems (e.g., welding, cutting, heating) that utilize CO₂, N₂, O₂, Ar, acetylene (C₂H₂), helium (He), hydrogen (H₂), compressed air, propane, natural gas, and other specialty gases.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a front view of an automatic changeover system.

FIG. 2 is a front view of the internal components of the automatic changeover system of FIG. 1.

FIG. 3 is a front view of the internal components of another embodiment of an automatic changeover system.

FIG. 4 is a front view of the internal components of another embodiment of an automatic changeover system.

### DETAILED DESCRIPTION

Throughout the following discussion, numerous references will be made regarding controllers. It should be appreciated that the use of such term is deemed to represent one or more computing devices having at least one processor configured to execute software instructions stored on a computer-readable tangible, non-transitory medium. For example, a controller can include one or more processors and software instructions operating in a manner to fulfill described roles, responsibilities, or functions. The automatic changeover systems described herein are configured and programmed to provide a continuous flow of a fluid to a fluid delivery system from multiple fluid sources.

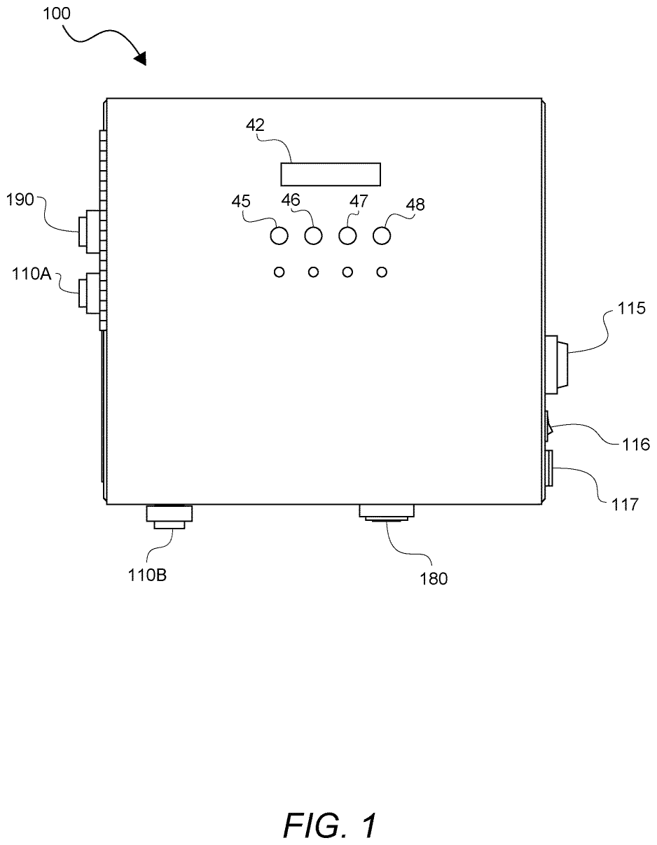

FIG. 1 shows an external view of an automatic changeover system 100. System 100 has a housing that protects the internal components. The sides of the housing have various ports, buttons, displays, and switches for operating system 100. The backside of the housing preferably has fastening mechanisms for mounting system 100 on a wall.

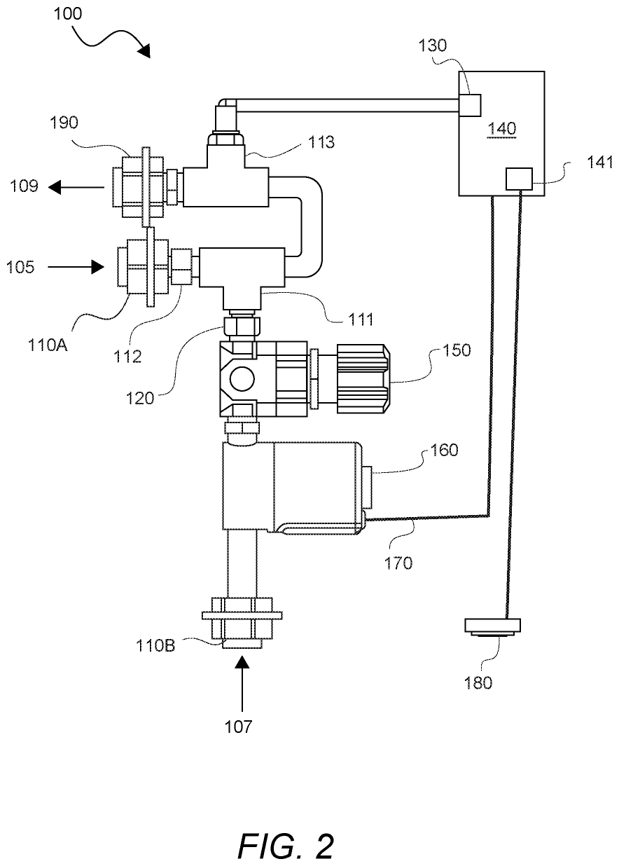

FIG. 2 shows an internal view of system 100. System 100 has a first inlet 110A configured to removably couple with a primary fluid source, and a second inlet 110B configured to removably couple with a secondary fluid source (e.g., backup or reserve source). System 100 also has an outlet 190 for delivering a fluid output to a downstream system. The fluid can be any liquid or gas used by the downstream system. For example, if the downstream system is a beverage delivery system, the fluid can comprise carbon dioxide (CO₂), nitrogen (N₂), or argon (Ar). Other downstream applications could comprise a medical gas pipeline system for oxygen (O₂) delivery or industrial gas delivery systems (e.g., welding, cutting, heating) that utilize CO₂, N₂, O₂, Ar, acetylene (C₂H₂), helium (He), hydrogen (H₂), compressed air, propane, natural gas, and other specialty gases.

The primary and secondary fluid sources typically comprise a high-pressure cylinder (e.g., tank, bank, reservoir) having a pressure of 800-3,000 pounds per square inch (PSI) or even greater. The high-pressure cylinder preferably has a pressure regulator that decreases the pressure of the fluid before the fluid enters first inlet 110A and second inlet 110B. For example, in the application of a beverage dispensing system, the inlet pressures are preferably below 200 PSI. Regulating the pressure to below 200 PSI reduces the cost of the components of system 100.

Once a primary fluid 105 enters first inlet 110A, it passes through a one-way valve 112. Valve 112 is configured and oriented to prevent fluid from flowing back into the primary fluid source. Valve 112 can be a check valve or any other one-way valve suitable for preventing backflow. After the primary fluid 105 passes through valve 112 it enters a junction 111. Junction 111 can be a manifold, hub, t-joint, or any other device that fluidly couples the primary fluid 105 with the secondary fluid 107 and the outlet 190.

Secondary fluid 107 enters second inlet 110B and passes through an actuated valve 160, a pressure regulator 150, and a one-way valve 120 before entering junction 111. Valve 120 is configured and oriented to prevent the primary fluid 105 from entering the secondary fluid source. Valve 120 can be a check valve or any other one-way valve suitable for preventing backflow. Actuated valve 160 is transitionable between an open state and a closed state to either allow or prevent the secondary fluid 107 from passing there-through. Actuated valve 160 is automatically operated by a controller 140 via an electrical connection 170. Actuated valve 160 can be a solenoid-operated valve or any other valve capable of being actuated by a controller.

After the primary fluid 105 and the secondary fluid 107 reach junction 111, they continue to flow through a line to outlet 190. The primary fluid 105 and the secondary fluid 107 exit outlet 190 as an outlet fluid 109. Outlet 190 is configured to removably couple with a downstream system so that outlet fluid 109 can be supplied to the downstream system.

Controller 140 comprises a processor, a non-transitory computer-readable medium, and software instructions. Controller 140 is programmed to automatically control the open/close state of actuated valve 160 based on a signal from pressure sensor 130. Pressure sensor 130 is configured and positioned to sense an outlet pressure. Pressure sensor 130 can comprise any type of sensor capable of sensing pressure and communicating that information to controller 140.

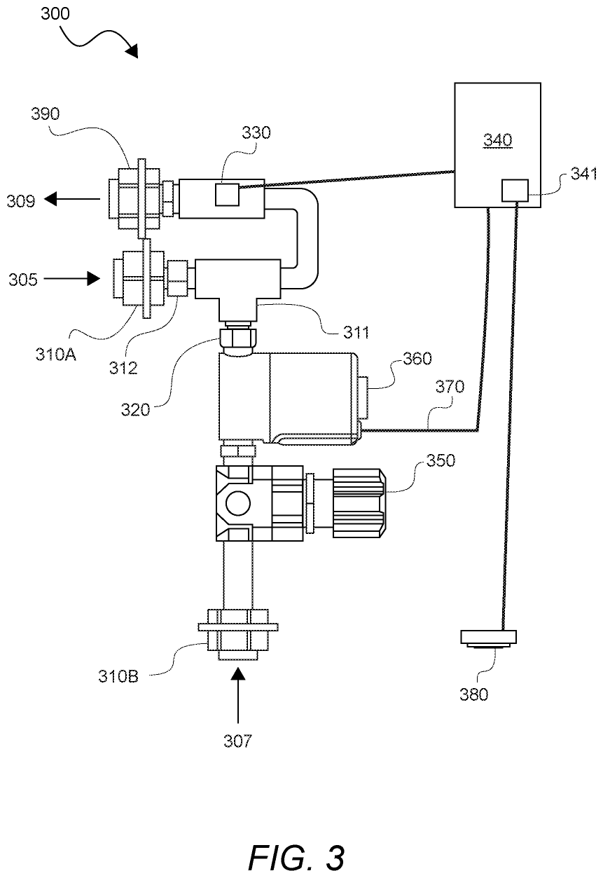

In one embodiment, pressure sensor 130 is an electrical sensor comprising a transducer that provides a continuous signal to controller 140. The signal can be a voltage, current, or digital data that represents a current value of the outlet pressure. In FIG. 2, pressure sensor 130 is shown as residing inside controller 140 (e.g., mounted on the printed circuit board), with a line that fluidly couples pressure sensor 130 to a junction 113 just upstream of outlet 190. However, it is also contemplated that pressure sensor 130 could reside in or at outlet 190, junction 111, or anywhere therebetween, as long as pressure sensor 130 senses a pressure of outlet fluid 109. FIG. 3 shows an alternative embodiment in which a pressure sensor 330 is disposed just upstream of outlet 390 and is electrically coupled with controller 340.

Controller 140 is programmed to open and close actuated valve 160 based on a preset first threshold pressure and second threshold pressure. The first threshold pressure is referred to as the changeover pressure. The difference between the first and second threshold pressures is referred to as the differential pressure. When the outlet pressure falls below the first threshold pressure, controller 140 changes actuated valve 160 from a closed state to an open state, allowing secondary fluid 107 to flow to outlet 190. When the outlet pressure rises above the second threshold pressure, controller 140 changes actuated valve 160 from the open state to the closed state, thereby preventing secondary fluid 107 from flowing to outlet 190. Primary fluid 105 continues to flow to outlet 190 regardless of the state of actuated valve 160 unless the primary fluid source is shut off at the source. This ensures that only a minimal amount of secondary fluid is consumed when actuated valve 160 is open and prolongs the life of the secondary fluid source.

Controller 140 is electrically coupled with an alarm 180. Alarm 180 can comprise an audible, visual, tactile, or any other sensory indication that can be interpreted by a user. Controller 140 has an alarm module 141 that is programmed to activate alarm 180 when actuated valve 160 is open. Alarm module 141 can be programmed to activate alarm 180 until it is manually shut off. Alarm module 141 can be programmed to activate alarm 180 for a specified period of time (e.g., 30 seconds) or a specified number of alerts (e.g., 10 beeps). Alarm module 141 can also be programmed to provide a second alert after it has already been manually turned off (e.g., if actuated valve 160 remains open for more than 12 hours, then alarm goes off again). Alarm module 141 can also be programmed to provide a delayed alert (e.g., alarm does not go off until actuated valve 160 is open for more than 1 hour). Alarm module 141 can also be programmed to have a delay between the alarm activation and the change of state of actuated valve 160. For example, alarm module 141 can be programmed so that an alarm goes off only when actuated valve 160 is opened for more than 15 seconds. This helps to prevent too many alarms from activating due to temporary changes in state of actuated valve 160 (which can occur due to brief moments of high demand). It is also contemplated that an alarm can activate first, followed by a delay before actuated valve 160 is opened. In other aspects, controller 140 can include a wireless transmitter for sending alarm notifications to a remote device such as a phone, tablet, or computer.

Pressure regulator 150 has a knob for manually adjusting its pressure regulation. Pressure regulator 150 is set to a pressure that is below the second threshold pressure to ensure that actuated valve 160 remains open until primary fluid 105 rises above the second threshold pressure. In other words, pressure regulator 150 prevents secondary fluid 107 from triggering a closed state of actuated valve 160. Pressure regulator 150 is also preferably set above the first threshold pressure to improve performance of the downstream system. However, system 100 will still function as intended even if pressure regulator 150 is set below the first threshold pressure.

Controller 140 is electrically coupled with a display 42 and buttons 45, 46, 47, 48, which are accessible from a front surface of the housing of system 100. Display 42 is programmed to show the state of actuated valve 160 (e.g., open or closed), outlet pressure, software version, changeover pressure setting, differential pressure setting, and an alarm state. Display 42 is also configured to provide instructions to the user (e.g., replace primary fluid source, replace secondary fluid source, leak detected).

Button 45 is used to display a home screen, which shows the status of actuated valve 160 and the outlet pressure. Button 46 is used to display the current setting for the changeover pressure. Button 47 is used to display the current setting for the differential pressure. Button 48 is used to display a version of the software. Buttons 45, 46, 47, 48 can also be used to adjust the changeover pressure and the differential pressure. Short pressing and long pressing buttons 45, 46, 47, 48 can send different instructions to controller 140.

System 100 has an on/off switch 115, a resettable circuit breaker 116, and a power connection 117 for supplying power to controller 140.

A method of using system 100 will now be explained. In one application, a user of system 100 is a restaurant that serves carbonated drinks. The user connects a primary CO₂ cylinder to first inlet 110A and a secondary CO₂ cylinder to second inlet 110B. The primary and secondary cylinders each have a pressure of 800 PSI. The primary gas passes through a pressure regulator that decreases primary gas pressure to 120 PSI before entering first inlet 110A. The secondary gas passes through a regulator that decreases secondary gas pressure to 115 PSI before entering secondary inlet 110B. The user connects outlet 190 to a beverage delivery system. Decreasing the pressure of the primary and secondary gas sources means that the user does not need to be a trained or licensed technician to install and program system 100.

The user manually adjusts the knob of pressure regulator 150 to 105 PSI. The user uses buttons 45, 46, 47, 48 to set the changeover pressure (e.g., first threshold pressure) to 100 PSI and the differential pressure to 10 PSI, which means the second threshold pressure is 110 PSI (e.g., 100 PSI+10 PSI). The user can determine what changeover pressure to use by asking the question: what is the lowest pressure that the outlet pressure can reach without compromising the performance of the beverage delivery system.

Controller 140 is programmed to prevent the user from selecting a differential pressure less than 0 PSI, and more preferably, less than 10 PSI. Controller 140 can also be programmed so that the differential pressure cannot be greater than a certain amount (e.g., 30 PSI). For example, the display can tell the user that the selected pressure is outside the acceptable range or the display can simply not allow for adjustment of the pressure beyond the acceptable range. A limited range helps to guide and prevent an untrained or unlicensed user from selecting a bad or non-functional setting.

Actuated valve 160 is closed by default when system 100 is first installed and turned on. After the user sets the changeover pressure and the differential pressure, controller 140 begins to monitor outlet pressure. Since the primary gas is initially coming in at 120 PSI, actuated valve 160 remains closed. However, once the primary gas pressure drops below 100 PSI, either because the primary gas source is depleted or there is a leak, then controller 140 opens actuated valve 160 and secondary gas begins to flow to outlet 190. Alarm module 141 activates alarm 180, which continues to alert the user until the user manually shuts off alarm 180. Actuated valve 160 will remain open until the primary gas pressure rises above 110 PSI. Secondary gas cannot trigger closure of actuated valve 160 since pressure regulator 150 is set to 105 PSI.

The user eventually replaces the primary gas source with a new CO₂ cylinder, which provides a primary gas pressure of 120 PSI at first inlet 110A. Controller 140 senses the increase of pressure at outlet 190 and closes actuated valve 160. System 100 only requires one sensor and one actuated valve to provide automatic changeover. Those of skill in the art will appreciate that the inventive subject matter provides a simple and low cost solution to automatic changeover needs. Pressure sensor 130 can be configured to detect a 2 PSI pressure spike within 10 seconds, providing greater sensitivity and resolution than many mechanical sensors and analog systems. System 100 is a reliable solution for low pressure systems.

Controller 140 can also be programmed to close actuated valve 160 and/or continuously activate the alarm when outlet pressure fails to rise above either the changeover pressure or the second threshold pressure after a certain period of time. This can occur when both the primary and secondary sources are low at the same time. Controller 140 could be configured to notify the user that secondary fluid pressure is too low.

The pressures recited above are merely one example. Those of ordinary skill in the art will appreciate that the pressure settings of system 100 can be adjusted based on the fluid and pressure requirements of the downstream application. Since the pressure settings and alarm settings are adjustable, system 100 provides dynamic fluid distribution that allows varying volumes of primary and secondary fluid sources to be supplied at the same time (while secondary fluid source is open) based on system pressures and backup status.

System 100 also provides backup alerts, such as audio/visual alarms to notify users of inadequate backup gas or primary fluid issues to ensure timely intervention. Alerts are provided when the state of the system changes. System 100 recognizes whether the backup gas turns on, whether there is any backup gas, and whether the backup gas has been on for over a certain period of time (e.g., 12 hours). The user can be required to silence the alarm manually, ensuring that at least one person on site is aware of the potential problem.

System 100 also allows for uninterrupted flow of the primary gas source in the event of a power outage. Loss of power causes actuated valve 160 to close, which stops the flow of secondary fluid but does not interfere with primary fluid flow. System 100 can never reach a stuck state that blocks the flow of the primary fluid.

FIG. 3 shows another automatic changeover system 300. System 300 is almost identical to system 100 except for two minor changes. Unlike system 100, system 300 has a pressure sensor 330 located just upstream of outlet 390 rather than being mounted to the printed circuit board of controller 340. Pressure sensor 330 is electrically coupled with controller 340 via a wired connection. However, it is also contemplated that pressure sensor 330 can communicate with controller 340 via a wireless connection, such as via Bluetooth. In that case, sensor 330 could have its own controller and printed circuit board. Sensor 330 could also communicate directly with actuated valve 360, either via a wired or wireless connection, and could be programmed to control and change the state of actuated valve 360. Sensor 330 could be further programmed to wirelessly communicate with a remote device, such as a phone or tablet. A user could program the control settings via the phone or tablet and controller 340 could be eliminated entirely, along with the display and buttons on the front of the housing of system 300.

System 300 also differs from system 100 in that pressure regulator 350 is located upstream of actuated valve 360. It is also contemplated that valve 320 could be located upstream of either pressure regulator 350 and/or actuated valve 360. The remaining components of system 300 correspond to the components of system 100 by the last two digits of their reference numbers and will not be discussed in detail.

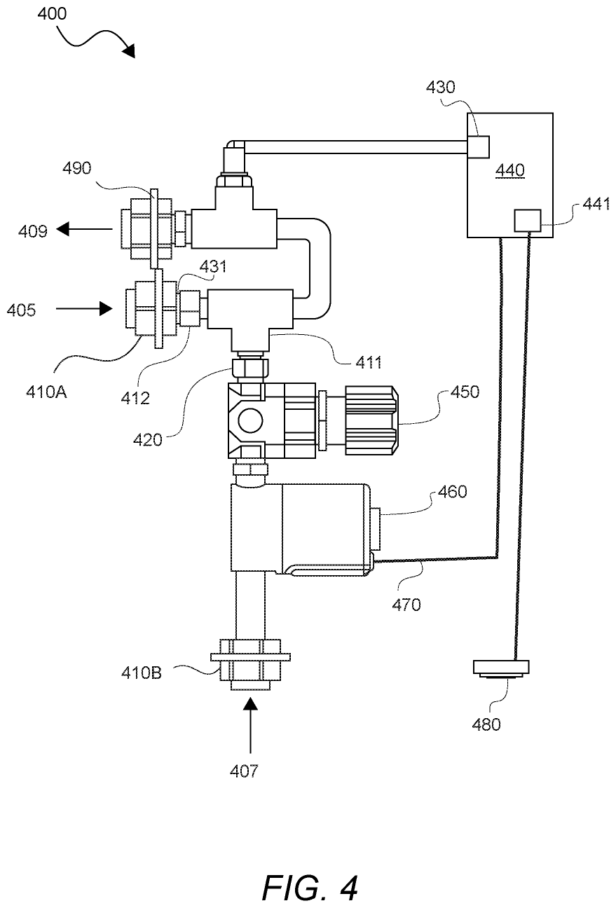

FIG. 4 shows another automatic changeover system 400. System 400 is almost identical to system 100 and reference numbers correspond to one another by their last two digits. System 400 is different from system 100 in that system 400 has an optional second pressure sensor 431 for sensing a pressure of the first inlet fluid. It is also contemplated that system 400 could have a third sensor for sensing a pressure of the second inlet fluid. It is also contemplated that sensor 431 could be located to sense the secondary fluid pressure rather than the first fluid pressure. Additional sensors add unnecessary costs to a changeover system. However, additional sensors can be helpful in determining whether the primary or secondary fluid pressures are too low.

In yet other embodiments, it is contemplated that a pressure regulator could be included between first inlet 110A and junction 111 to limit the pressure of primary fluid 105.

This specification provides many example embodiments of the inventive subject matter. Although each embodiment represents a single combination of inventive elements, the inventive subject matter is considered to include all possible combinations of the disclosed elements. Accordingly, if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The recitation of ranges of values herein is merely intended to serve as a shorthand method of referring individually to each separate value falling within the range. Unless otherwise indicated herein, each individual value is incorporated into the specification as if it were individually recited herein, and ranges include their endpoints.

In some embodiments, the numbers expressing quantities and properties to describe and claim certain embodiments of the inventive subject matter are to be understood as being modified in some instances by the term “about.” Accordingly, in some embodiments, the numerical parameters set forth in the written description and attached claims are approximations that can vary depending upon the desired properties and functions sought to be obtained or performed by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the inventive subject matter may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention. Unless a contrary meaning is explicitly stated, all ranges are inclusive of their endpoints, and open-ended ranges are to be interpreted as bounded on the open end by commercially feasible embodiments.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An automatic changeover system comprising:
a first inlet;
a second inlet;
an outlet;
a junction having a first port fluidly coupled with the first inlet, a second port fluidly coupled with the second inlet, and a third port fluidly coupled with the outlet;
an actuated valve fluidly coupled between the second inlet and the second port of the junction;
a pressure regulator fluidly coupled between the second inlet and the second port of the junction in series with the actuated valve;
a pressure sensor configured to sense outlet pressure; and
a controller electrically coupled with the pressure sensor and actuated valve and programmed to selectively actuate the actuated valve based on the outlet pressure.

2. The automatic changeover system of claim 1, wherein there are no pressure sensors fluidly coupled between the first inlet and the first port of the junction.

3. The automatic changeover system of claim 2, wherein there are no pressure sensors fluidly coupled between the second inlet and the second port of the junction.

4. The automatic changeover system of claim 3, wherein the pressure sensor positioned to sense outlet pressure is the only pressure sensor fluidly coupled between or at the outlet and the junction.

5. The automatic changeover system of claim 1, further comprising a check valve fluidly positioned between the first inlet and the first port of the junction.

6. The automatic changeover system of claim 1, further comprising a check valve fluidly positioned between the second inlet and the second port of the junction.

7. The automatic changeover system of claim 6, wherein the check valve is downstream of the pressure regulator and the actuated valve.

8. The automatic changeover system of claim 7, wherein the pressure regulator is downstream of the actuated valve.

9. The automatic changeover system of claim 1, wherein the controller is programmed to open the actuated valve when the outlet pressure falls below a first threshold pressure.

10. The automatic changeover system of claim 9, wherein the controller is programmed to close the actuated valve when the outlet pressure rises above a second threshold pressure.

11. The automatic changeover system of claim 10, wherein the second threshold pressure is greater than the first threshold pressure and less than a preferred operating pressure of the first inlet.

12. The automatic changeover system of claim 11, wherein the pressure regulator is adjusted to maintain pressure downstream of the pressure regulator to below a third threshold pressure.

13. The automatic changeover system of claim 12, wherein the third threshold pressure is between the first threshold pressure and the second threshold pressure.

14. The automatic changeover system of claim 1, further comprising an alarm electrically coupled with the controller.

15. The automatic changeover system of claim 14, wherein the alarm is audible, visual, or tactile.

16. The automatic changeover system of claim 15, wherein the controller is programmed to activate the alarm when the actuated valve is open.

17. The automatic changeover system of claim 1, further comprising a housing that encloses and protects the junction, controller, pressure regulator, actuated valve, and pressure sensor.

18. The automatic changeover system of claim 1, further comprising a display or interface electrically coupled with the controller.

19. The automatic changeover system of claim 18, wherein the controller is configured to show a status of the actuated valve, an outlet pressure, a software version, a setting for the first threshold pressure, a setting for the second threshold pressure, and a recommended action.

20. The automatic changeover system of claim 1, wherein the first inlet is configured to couple with a primary gas source, the second inlet is configured to couple with a secondary gas source, and the outlet is configured to couple with a beverage dispensing system.
